(19) United States
(12) Patent Application Publication
(10) Pub. No.: US 2014/0192705 A1
(43) Pub. Date: Jul. 10, 2014

(54) Selective Relaying in a Network Node

(71) Applicants: Vicknesan Ayadurai, Sollentuna (SE); Mikael Prytz, Ronninge (SE)

(72) Inventors: Vicknesan Ayadurai, Sollentuna (SE); Mikael Prytz, Ronninge (SE)

(73) Assignee: TELEFONAKTIEBOLAGET L M ERICSSON (PUBL), Stockholm (SE)

(21) Appl. No.: 14/127,619

(22) PCT Filed: Jun. 20, 2011
(86) PCT No.: PCT/SE2011/050799

§ 371 Date: Dec. 19, 2013

(51) Int. Cl. H04B 7/155

(52) U.S. Cl. CPC H04B 7/15528; H04B 7/15507
USPC 370/315

(57) ABSTRACT

Network node (110) and method in the network node (110), for forwarding a wirelessly transmitted data packet to a second network node (120), which data packet was received from a third network node (130) with the second network node (120) as the intended recipient. The method comprises monitoring (501) data packets exchanged between the second network node (120) and the third network node (130), determining (502) that a wireless communication session is established between the second and third network nodes (120, 130), measuring (503) received signal power of wireless signals received from the second and third network nodes (120, 130), respectively, on at least two different points in time, detecting (504) a difference over time of measured (503) received signal power, identifying (506) that a data packet, transmitted by the third network node (130) is not received by the second network node (120), forwarding (507) the data packet, identified (506) as not received.

### TECHNICAL FIELD

The present disclosure relates to a network node and a method in a network node. In particular, it relates to relaying of wirelessly transmitted data packets within a communication session between two other network nodes.

### BACKGROUND

Network nodes, such as e.g. User Equipment (UE), also known as mobile stations, wireless terminals and/or mobile terminals are enabled to communicate wirelessly in a wireless communication system, sometimes also referred to as a cellular radio system. The communication may be made e.g. between two user equipment units, between a user equipment and a regular telephone and/or between a user equipment and a server via a Radio Access Network (RAN) and possibly one or more core networks.

The user equipment units may further be referred to as mobile telephones, cellular telephones, e-readers, laptops with wireless capability etc. The user equipment units in the present context may be, for example, portable, pocket-storable, hand-held, computer-comprised, or vehicle-mounted mobile devices, enabled to communicate voice and/or data wirelessly, via the radio access network, with another entity, such as another user equipment or a server.

However, the network nodes herein discussed may comprise a base station e.g. a Radio Base Station (RBS), which in some networks may be referred to as “eNB”, “eNodeB”, “NodeB” or “B node”, depending on the technology and terminology used. The network nodes may be of different classes such as e.g. macro eNodeB, home eNodeB or pico base station, based on transmission power and thereby also cell size. A cell is the geographical area where radio coverage is provided by the network node/base station at a base station site. One base station, situated on the base station site, may serve one or several cells. The network nodes communicate over the air interface operating on radio frequencies with the user equipment units within range of the respective network node.

However, the network nodes and wireless systems as discussed herein may further comprise other communication paradigms, such as short wavelength radio transmissions over e.g. Bluetooth (trademark), Wi-Fi network, Wireless Personal Area Network (WPAN), Wireless Local Area Network (WLAN), a wireless broadband network and/or network based on broadcasting of wireless data.

Consider a wireless system with a source node A, and a destination node B, using a broadcast channel on which, in general, any node within the wireless system may hear any other node in its vicinity. The source node A may transmit information packets to the destination node B over the air, which in turn may acknowledge the data transmission appropriately. The strength of this transmitted signal attenuates as it travels through the medium. If the separation between the two nodes A and B increases, a point is reached when destination node B will no longer be able to process the received signal, and the communications link between node A and node B is broken.

A separate relaying device, node R, listening in on the same frequency may be placed in between node A and node B above. Node R may still receive the transmission from node A, even when node B no longer does, e.g. in case node B has been moved geographically. This relaying device, node R, may then relay the received signal from node A and since it is located midway between node A and node B, this relayed signal may be successfully received at node B.

By turning the relaying node R on when needed, the communication between node A and node B may be maintained at longer ranges, effectively increasing the signal coverage of the two original nodes A and B, respectively.

In the above described scenario, data is communicated between node A and node B via node R in two phases. In Phase I, node R receives the transmitted data from node A. In Phase II, this data at node R is relayed, i.e. transmitted and received at node B. This two-phase mechanism may conventionally be referred to as “decode-and-forward”, keeps the node A to node B link up, but at a cost of inefficiently utilizing the shared medium.

It would be prudent to ensure that the relaying node R is controlled tightly, being enabled only when necessary, and disabled whenever the direct link between node A and node B is back up, so as not to occupy the shared medium un-necessarily. The challenge then lies in determining when and how node R should be turned on, and conversely, turned off, when it is no longer needed.

Existing solutions typically employ signalling mechanisms to enable or disable relaying functionality depending on current conditions. In these scenarios certain nodes are explicitly designated as relays, and subsequently, other surrounding nodes adapt their routing mechanisms to utilize these relaying nodes when needed.

Characteristically, these previously known solutions involve explicit signalling mechanisms and system-wide awareness and co-operation by all nodes in order to work. These approaches are both complex and, from various aspects, expensive.

### SUMMARY

It is therefore an object to obviate at least some of the above mentioned disadvantages and to improve the performance in a wireless communication system.

According to a first aspect, the object is achieved by a method in a first network node. The method aims at forwarding a wirelessly transmitted data packet to a second network node, which data packet was received from a third network node with the second network node as the intended recipient of the data packet. The method comprises monitoring data packets exchanged between the second network node and the third network node. Further, the method comprises determining that a wireless communication session is established between the second network node and the third network node. Additionally, the method also comprises measuring received signal power of wireless signals received from the second network node and from the third network node, respectively, on at least two different points in time. Furthermore, the method in addition comprises detecting a difference over time of measured received signal power of wireless signals received from at least one of the second network node and the third network node. Also, in further addition, the method comprises identifying that a data packet, transmitted by the third network node is not received by the second network node. The method also comprises, in addition, forwarding the monitored data packet, identified as not received by the second network node, to be received by the second network node.

According to a second aspect, the object is achieved by a network node. The network node aims at forwarding a wirelessly transmitted data packet to a second network node, which data packet was received from a third network node, with the second network node as the intended recipient of the data packet. The network node comprises a receiver, configured to receive wireless signals from the second network node and from the third network node respectively. Further, the network node comprises a processing circuit, configured to monitor data packets exchanged between the second network node and the third network node. The processing circuit is further configured to determine that a wireless communication session is established between the second network node and the third network node. The processing circuit is in addition also configured to measure the received signal power of wireless signals received from the second network node and from the third network node, respectively, on at least two different points in time. The processing circuit in addition, also configured to detect a difference over time of measured received signal power of wireless signals received from at least one of the second network node and the third network node. Additionally, the processing circuit is also configured to identify that a data packet, transmitted by the third network node is not received by the second network node. Also, the network node comprises a transmitter, configured to forward the monitored data packet, identified as not received by the second network node, to be received by the second network node.

Embodiments of the method and network node described herein presents a way in which the range and quality of communications between network nodes on a wireless broadcast medium may potentially be extended with the help of the described relaying network node.

An advantage of embodiments described herein is that it provides this feature without any specific changes to the existing network architecture or infrastructure, or even to existing protocols in use. Embodiments of the first network node may thus comprise a relay functionality and be configured to operate within a system of wireless network nodes, transparently providing the relay functionality when appropriate. Thereby it is possible to extend the range and quality of communications between two other network nodes on a wireless broadcast medium.

To use the medium efficiently the relaying network node may repeat packets of an ongoing session when that session's link is failing. The first network node does this by silently learning about the quality of ongoing communications sessions and turning itself on, or conversely, off, when needed, autonomously without any external intervention. Existing network nodes within the network may continue with their ongoing communications, possibly oblivious of the fact that their transmissions to each other are being relayed by the first network node. Thereby, an improved performance within the wireless communication system is achieved.

Other objects, advantages and novel features will become apparent from the following detailed description of the present method and user equipment.

### BRIEF DESCRIPTION OF THE DRAWINGS

The methods and network nodes are described in more detail with reference to attached drawings illustrating exemplary embodiments in which:

FIG. 1 is a schematic illustration of a wireless communication system for communicating data between network nodes, according to some embodiments.

FIG. 2 is a combined flow chart and block diagram illustrating an example of an embodiment of the present methods.

FIG. 3A is a schematic illustration of a wireless communication system for communicating data between network nodes, according to some embodiments.

FIG. 3B is a schematic illustration of a wireless communication system for communicating data between network nodes, according to some embodiments.

FIG. 4A is a schematic illustration of a wireless communication system for communicating data between network nodes, according to some embodiments.

FIG. 4B is a schematic illustration of a wireless communication system for communicating data between network nodes, according to some embodiments.

FIG. 5 is a schematic flow chart illustrating an example of an embodiment of a method in a network node.

FIG. 6 is a schematic block diagram illustrating an example of an embodiment of a network node.

### DETAILED DESCRIPTION

Embodiments herein are defined as a network node and a method in a network node, which may be put into practice in the embodiments described below. These embodiments may, however, be exemplified and realised in many different forms and are not to be considered as limited to the embodiments set forth herein; rather, these embodiments are provided so that this disclosure will be thorough and complete.

Still other objects and features may become apparent from the following detailed description considered in conjunction with the accompanying drawings. It is to be understood, however, that the drawings are designed solely for purposes of illustration and not as a definition of the limits of the herein disclosed embodiments, for which reference is to be made to the appended claims. It is further to be understood that the drawings are not necessarily drawn to scale and that, unless otherwise indicated, they are merely intended to conceptually illustrate the structures and procedures described herein.

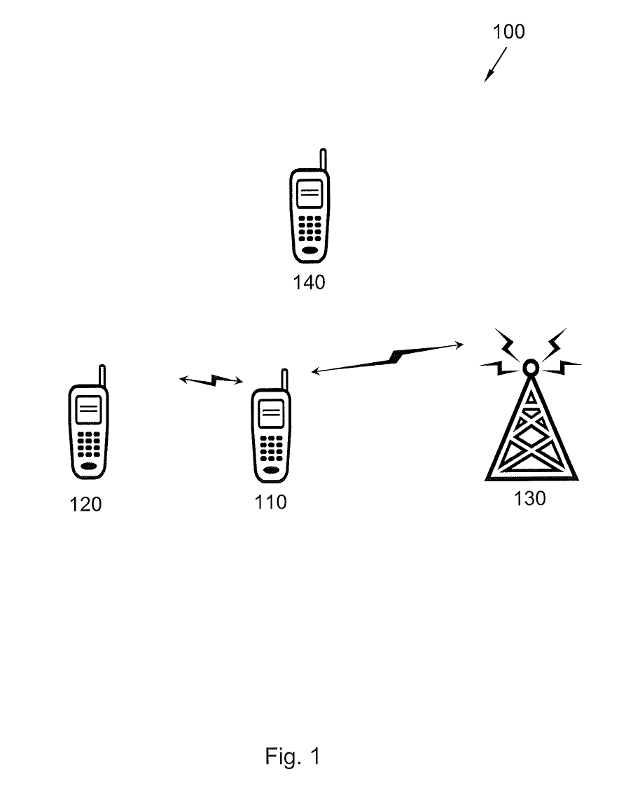

FIG. 1 depicts a wireless communication system 100. The wireless communication system 100 may be based on technologies providing broadcasting information or data over a broadcast channel. Such technologies may comprise e.g. Wireless Local Area Network (WLAN), Wi-Fi network, Wireless Personal Area Network (WPAN), Bluetooth (trademark) or a wireless broadband network and/or network based on broadcasting of wireless data.

However, embodiments of the wireless communication system 100 may at least partly be based on radio access technologies such as e.g. 3rd Generation Partnership Project (3GPP) Long Term Evolution (LTE), LTE-Advanced, Evolved Universal Terrestrial Radio Access Network (E-UTRAN), UMTS, GSM/Enhanced Data rate for GSM Evolution (GSM/EDGE), Wideband Code Division Multiple Access (WCDMA), Worldwide Interoperability for Microwave Access (WiMax), or Ultra Mobile Broadband (UMB), Evolved Universal Terrestrial Radio Access (E-UTRA), Universal Terrestrial Radio Access (UTRA), GSM EDGE Radio Access Network (GERAN), 3GPP2 CDMA technologies e.g. CDMA2000 1×RTT and High Rate Packet Data (HRPD), just to mention some few exemplary options.

However, other embodiments of the wireless communication system 100 may further be based on Citizens' Band (CB) radio, Ultra-High Frequency (UHF), Family Radio Service (FRS), General Mobile Radio Service (GMRS), Private Mobile Radio, 446 MHz (PMR446), Private Mobile Radio (PMR), digital Private Mobile Radio (dPMR), Push-to-talk (PTT), Personal Handy-phone System (PHS), Personal Access System (PAS), or any other similar technology, appropriate for amateur radio, and/or emergency services communications.

The wireless communication system 100 comprises at least a first network node 110, a second network node 120 and also a third network node 130. Possibly, according to some embodiments, a fourth further network node 140 may be comprised. The first network node 110, the second network node 120, the third network node 130 and the fourth network node 140, if any, are configured to communicate wirelessly with each other and to be either stationary or mobile. Further, the network nodes 110, 120, 130, 140 may be represented by e.g. a wireless communication terminal, a mobile cellular phone, a Personal Digital Assistant (PDA), a wireless platform, a mobile station, a portable communication device, an e-reader, a laptop, a computer, a wireless terminal acting as a relay, a relay node, a mobile relay, a Customer Premises Equipment (CPE), a Fixed Wireless Access (FWA) nodes, a walky-talky, a handheld transceiver, a baby monitor, a cordless telephone, a game station, a media player, a base station, a NodeB, an evolved Node B (eNB, or eNode B), a base transceiver station, an Access Point Base Station, a base station router, a Radio Base Station (RBS), a macro base station, a micro base station, a pico base station, a femto base station, a Home eNodeB, a relay and/or a repeater, a sensor, a beacon device or any other kind of device configured to communicate wirelessly with other network nodes 110, 120, 130, 140.

However, according to some embodiments, the network nodes 110, 120, 130, 140 may comprise house hold appliances, such that e.g. toaster, freezer, refrigerator, stove, cooker, oven, cooking plate, cooktop, microwave oven, washing equipment, washing machine, clothes dryer, drying cabinet, dishwasher, air conditioner, water heater, trash compactor, blender, printer, vacuum cleaner, steamer, food processor, heating system, water heater, thermostat, air conditioner, light control system, home robot, television set, gaming device, intrusion detection, fire alarm, garage door sensor, coffee brewer etc.

In the rest of this disclosure, the term “first network node”, “second network node”, “third network node” and “fourth network node”, respectively will be used for the first network node 110, the second network node 120, the third network node 130 and the fourth network node 140, respectively, in order to facilitate the comprehension of the present methods.

It is further to be noted that the illustrated network setting of network nodes 110, 120, 130, 140 in FIG. 1 is to be regarded as a non-limiting exemplary embodiment only. The wireless communication system 100 may comprise any other number and/or combination of network nodes 110, 120, 130, 140, although four instances of network nodes 110, 120, 130, 140, respectively are illustrated in FIG. 1 for clarity reasons. A plurality of network nodes 110, 120, 130, 140 may further be involved in the present methods according to some embodiments.

Thus whenever “one” or “a/an” network node 110, 120, 130, 140 is referred to in the present context, a plurality of network nodes 110, 120, 130, 140 may be involved, according to some embodiments.

The purpose of the illustration in FIG. 1 is to provide a simplified, general overview of the present method and the functionalities involved.

The third network node 130 transmits a data packet to be received by the second network node 120. However, the second network node 120 may, for some reason or another, not be able to receive, or decode the data packet. The first network node 110 may then forward and relay the data packet, such that the second network node 120 could receive the data packet. The first network node 110 may thus act as a relay apparatus capable of enabling and/or disabling its relaying functionality autonomously.

According to some embodiments, the first network node 110 may listen in transmissions made between other network nodes 120, 130 on the shared broadcast medium within the wireless communication system 100, before initiating any relaying of data. Thereby, the first network node 110 may establish that the other network nodes 120, 130 have an ongoing communication session.

The first network node 110 may according to some embodiments be independent of the existing system setup, and other network nodes 120, 130 in the wireless communication system 100 may be unaware of its presence. Thus the relaying may be made by the first network node 110 transparently between the other network nodes 120, 130, according to some embodiments.

Operating on a shared broadcast medium, the first network node 110 is able to overhear physical signal strengths of ongoing transmissions from the surrounding nodes, such as the second and third network nodes 120, 130.

Additionally, the first network node 110 may also be aware of the protocols being used by the surrounding network nodes 120, 130. Such protocols may comprise e.g. Media Access Control (MAC), Internet Protocol (IP), Transmission Control Protocol (TCP), etc. Thereby, the first network node 110 may be able to distinguish between the different packet types it may overhear. Further, the first network node 110 may understand and comply with the rules for accessing this shared medium, e.g., using Carrier Sense Multiple Access with Collision Avoidance (CSMA/CA), according to some embodiments.

By observing the above cross-layer heuristics of ongoing communications between the other network nodes 120, 130, the first network node 110 may be able to make deductions on link quality autonomously. For example, this may be made from protocol re-transmissions on an ongoing link between the second and third network nodes 120, 130, together with signal strength fluctuations, the first network node 110 may be able to deduce that the link may be about to fail due to increasing physical separation between the two communicating network nodes 120, 130.

Based on this deduction the first network node 110 may relay packets it overhears from the two communicating network nodes 120, 130 in the failing link, performing as a “decode-and-forward” repeater.

By similar arguments, the first network node 110 may be able to deduce that a failed link is recovering e.g., from duplicate packets seen, increasing signal-strengths, etc. and hence, cease its relaying functionality.

In this manner the first network node 110 provides relaying functionality for existing network nodes 120, 130 in its vicinity whenever needed, and transparently to the overall wireless communication system 100 of wireless network nodes 110, 120, 130, 140.

Further, embodiments disclosed herein provide a mechanism for controlling the autonomous forwarding of data in the first network node 110. According to some embodiments, the forwarding of data in the first network node 110 is activated for established connections between other network nodes 120, 130, which are desired by both communicating parts, but not when for example one of the parts just do not want to communicate with the other, signal transmitting part and for that reason does not acknowledge the communication. Further, according to some embodiments, the forwarding of data in the first network node 110 is activated when it is needed to uphold the communication between the communicating second and third network nodes 120, 130, but deactivated at the moment when they are able to uphold the communication themselves. Thereby, it may be avoided that the forwarding of data by the first network node 110 interferes with the communication between the second and third network node 120, 130. In addition, according to some embodiments, the forwarding of data in the first network node 110 is not activated when it is detected that another network node 140 has already started to forward data packets in the communication link between the second and third network nodes 120, 130.

These and other features of embodiments disclosed herein will be further explained in more detail subsequently.

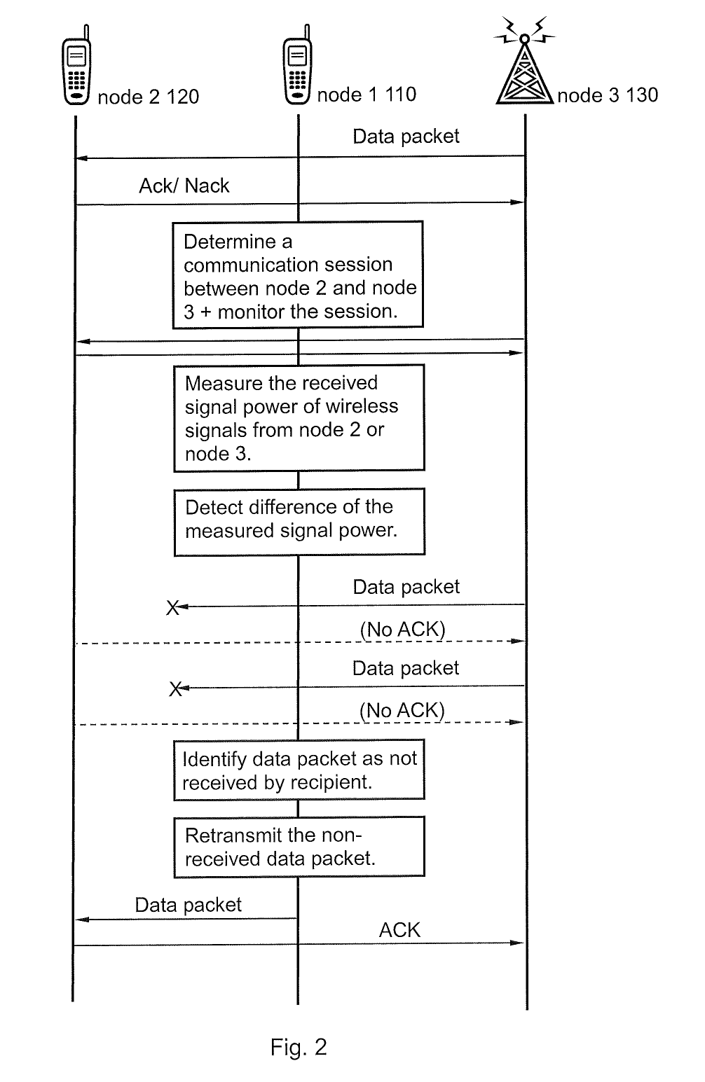

FIG. 2 is a combined flowchart and block diagram illustrating an overview of an exemplary, non-limiting embodiment of a method in a first network node 110, for forwarding data packets to a second network node 120, from a third network node 130.

The method may comprise a plurality of actions, in order to efficiently relaying data packets between the neighbouring network nodes 120, 130 in the wireless communication system 100, such as the actions subsequently described.

However, the described actions may be performed in a somewhat different order than the herein utilised order of appearance, which is merely exemplary according to different embodiments. Also, some of the described actions may be performed within some alternative embodiments, but not necessarily within all embodiments, while some further additional actions, described in more detail elsewhere within this disclosure may be performed within some embodiments.

Firstly, the third network node 130 may send a data packet to be received by the second network node 120. The second network node 120 receives the data packet and acknowledges it by transmitting an acknowledgement (ACK), to be received by the third network node 130.

The first network node 110 may then, based on this, or other detected signalling of the second and third network nodes 120, 130, determine that a communication session is ongoing between the second network node 120 and the third network node 130. Further, the first network node 110 may monitor the communication session, and/or the data packets exchanged between the second network node 120 and the third network node 130.

Further the first network node 110 may measure the received signal power of wireless signals from the second network node 120 and the third network node 130, respectively. The received signal power of wireless signals may comprise Reference Signal Received Power (RSRP). In addition, the received signal power of wireless signals may be measured at various points in time, such as e.g. continuously according to some embodiments. Thereby, the first network node 110 may detect differences between the measured received signal power of wireless signals from any of the second network node 120 and/or the third network node 130.

If such difference is detected from any of the second network node 120, or the third network node 130, it may be interpreted such that e.g. the network node 120, 130 is moving in relation to the first network node 110, or that an obstacle, such as a building or similar is suddenly mounted in between the second network node 120 and the third network node 130 in the signal propagation path. This may in turn cause that data packets transmitted between the second network node 120 and the third network node 130 may be lost. Thus the first network node 110, according to some embodiments, upon detecting such difference of received signal power over time, e.g. a difference exceeding a certain threshold value, may be set into an increased alert mode, preparing for relaying data packets between the communicating network nodes 120, 130, e.g. by start buffering detected data packets communicated between the second and third network nodes 120, 130 in a buffer. Thereby the first network node 110 may be prepared for immediately start forwarding the buffered data, when it is determined to start forwarding data, according to some embodiments.

Further, the first network node 110 may detect and identify that a data packet, transmitted by the third network node 130 is not received by the second network node 120, or vice versa, within the communication session between the network nodes 120, 130. Such detection may be made in a plurality of ways, e.g. by detecting a retransmission of the data packet, made by the third network node 130, i.e. that the third network node 130 is retransmitting the same data packet for a certain number of times. However, the first network node 110 may detect that the second network node 120 has not transmitted an acknowledgement for the data packet, according to some embodiments. In addition, the first network node 110 may detect that the second network node 120 has transmitted a non-acknowledgement for the data packet according to some embodiments.

Then, when the first network node 110 has ascertained that the second and third network nodes 120, 130 has an ongoing communication session, that the signal propagation conditions of at least one of the involved network nodes 120, 130 has changed, and that data packets communicated between the second node 120 and the third node 130 is lost, the first network node 110 may forward, i.e. relay the data packet identified as not received by the intended recipient. Thereby the data packet, identified as not received by the second network node 120, may be forwarded to be received by the second network node 120, according to some embodiments.

The illustrated example of an embodiment of the method in the first network node 110 may kick in autonomously, e.g. when the above stipulated criterions are fulfilled according to some embodiments.

Details according to some embodiments of the described method will be further described in the subsequent figures.

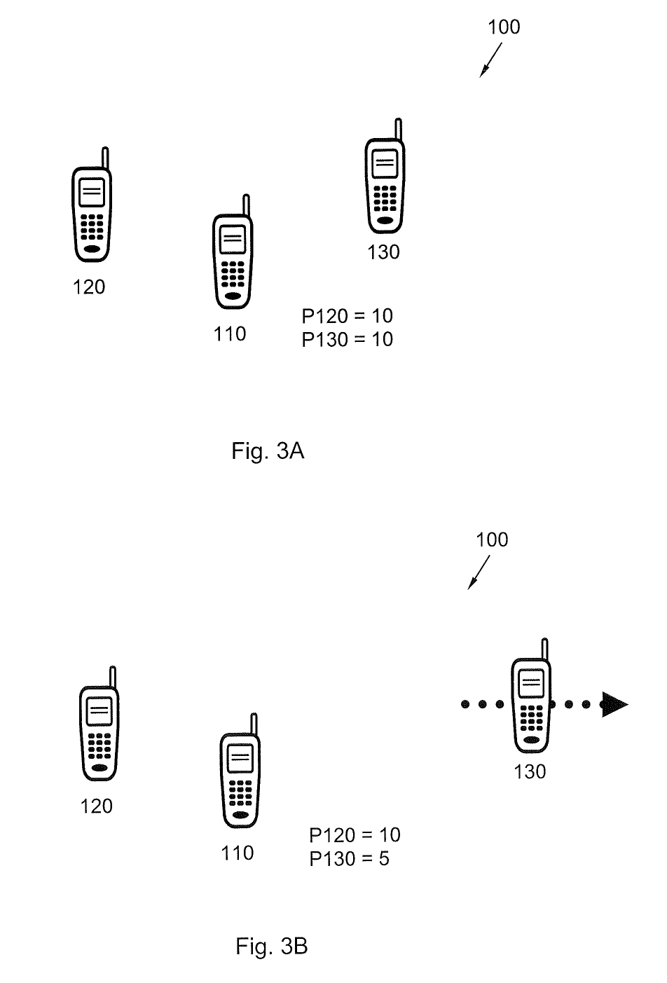

FIG. 3A is illustrating the first network node 110, the second network node 120 and the third network node 130, situated in relative vicinity, in a radio sense, of each other. The second network node 120 and the third network node 130 have an ongoing communication session. Based on traffic it overhears, the first network node 110 then may build up a table of current point-to-point communications sessions, and the corresponding signal power strengths, such as e.g. Reference Signal Received Power (RSRP) of the two network nodes 120, 130 involved in each link, e.g.:

TABLE 1
A 2-entry session table built up by the overhearing apparatus

| Session | Source | Destination | P_{source} | P_{destination} |
|---|---|---|---|---|
| 1 | Node 130 | Node 120 | P_{130/120} | P_{120/130} |
| 2 | Node X | Node Y | P_{XY} | P_{YX} |

It may be assumed that the first network node 110 understands the protocols utilized by the second network node 120 and the third network node 130 in their mutual communication. In an example of an embodiment a Media Access Control (MAC) address may be utilised, enabling identification of communicating parts and making it possible to distinguish between the different network nodes 120, 130 present, based on addressing. Each time a new data packet is detected on the shared medium, the table may be updated with new signal strengths, Pxy, where Pxy is the signal power of transmission from node X to be received by node Y as seen (i.e. measured) by the first network node 110.

The first network node 110 may continuously monitor the communications over the broadcast medium. Assuming the channel remains relatively stationary over time, the above power readings may remain fairly constant when/if none of the network nodes 110, 120, 130 are moving.

In the FIG. 3A is an embodiment of the method illustrated, in a wireless communication system 100 comprising three network nodes 110, 120, 130. The second network node 120 and the third network node 130 are communicating with each other, while the first network node 110 may overhear their exchanged data packets over the shared channel. P120 and P130 in Table 1, may represent the signal power observed by the first network node 110 for packets going from the second network node 120, to be received by the third network node 130, and from the third network node 130 to the second network node 120 respectively, given in some arbitrary unit, and are both assumed to be identical and constant, according to some embodiments.

A unidirectional information stream going from the second network node 120 to the third network node 130 may be assumed according to some embodiments. For each successfully received data packet at the second network node 120, the second network node 120 may send a corresponding acknowledgement, ACK, packet back to be received by the third network node 130 i.e., control messages may be present in both directions of the communication.

As illustrated in FIG. 3A, the first network node 110 initially may be located midway between the second network node 120 and the third network node 130, and may receive a signal power of 10 for data packets in both directions when the communication link between the second network node 120 and the third network node 130 is good, according to some embodiments.

The third network node 130 may then according to the illustrated example commence to physically move away towards the right as shown, causing the first network node 110 to see a decreasing P130 when this happens, which is a scenario further illustrated in FIG. 3B.

At some point, if the distance between the second network node 120 and the third network node 130 keeps increasing, the physical signals may become too weak at the end network nodes 120, 130 to be successfully processed and MAC retransmissions occur.

In such event, based on both the varying received power levels, as well as the MAC retransmissions observed, the first network node 110 may understand the current topology of the network and may commence relaying the data packets between the second network node 120 and the third network node 130, as well as the corresponding ACK packets from the third network node 130 back to the second network node 120, in an attempt to keep the link up.

When one of the power readings from any of the different network nodes 120, 130 begins to vary, either increasing or decreasing, from its ‘constant’ value collected e.g. in Table 1 above, this may be interpreted as the network node 120, 130 is in motion and physical separations are changing.

It may further be assumed that the protocols in use support reliable transmission in the form of re-transmissions. This may be implemented as a stop-and-wait type of MAC protocol and/or something more elaborate higher up the stack, such as e.g. Transmission Control Protocol (TCP), according to some embodiments.

When the power readings start to vary, the first network node 110 may closely monitor the protocol/s in use to detect any link-repair operations or re-transmissions which may be taking place. Additionally, the first network node 110 may also begin buffering the latest packet overheard from the sending third network node 130.

Subsequently, if signal strengths further decrease at the original network nodes 120, 130, re-transmissions begin to take place between them. At some point the first network node 110 might see one other network node 120, 130 sending an identical packet out multiple times, i.e., retransmissions, with no response from the recipient network node 120, 130. This may be considered to be a broken link between the original two communicating network nodes 120, 130, according to some embodiments.

The first network node 110 may now proceed to repeat the last packet from the source network node 120, 130 it has buffered, verbatim, according to some embodiments. If the first network node 110 is situated closer to the destination network node 120, 130, this repeated data packet may be received by the destination network node 120, 130, which has no reason to believe this data packet is not the original transmission from the sender network node 120, 130. Hence, a corresponding response, i.e. acknowledgement may be generated. With the assumption that the link is broken in both directions, the first network node 110 may then also repeat the response as well, to ensure that it gets to the original source host, i.e. the original sender network node 120, 130.

Communication for the session between the original two network nodes 120, 130 may take place via the first network node 110, which may function as a conventional “decode-and-forward” repeater, possibly without the knowledge of the two original network nodes 120, 130. However, the first network node 110 may cease its forwarding function the moment the original two network nodes 120, 130 come within direct-range again, so as not to occupy the shared medium unnecessarily.

This may be achieved in numerous ways. According to some embodiments, the first network node 110 may take a “wait-and-see” approach, and intermittently delay its relaying transmissions slightly. If the original two network nodes 120, 130 come within direct contact again, then the first network node 110 may see the normal communications responses, acknowledgments, take place, and it may then cease being a repeater for this communication session.

It may also be mentioned that while the first network node 110 is acting as a repeater in the ongoing communication session between the second network node 120 and the third network node 130, it may still continuously monitor the status of other ongoing communication sessions between other network nodes, and may potentially function as repeater also for any, some or all of these sessions as well, in the same manner as described above, in parallel.

In the event that the existing network nodes 120, 130 utilize power-control in their transmissions, the above mechanism may still work. The first network node 110 may exploit the cross-layer properties of physical-layer signal-strengths as well as higher-layer protocol retransmissions in making its decision to relay data packets. This combination may still detect link failure once maximum power levels have been reached.

The first network node 110 is envisioned to be present in the wireless communication system 100 in an unplanned ad-hoc manner. In the event that several instances of the first network node 110, which thus may function as a multiple relay apparatus, are present, a simple contention avoidance mechanism may be introduced to ensure that only one of them activates when needed, for a specific session. This may be implemented by introducing a random timer, which decides when the first network node 110 commences relaying packets, once determining that the communication session link is down.

It has herein only been discussed a scenario wherein the first network node 110 is configured as a single relay apparatus i.e., single-hop between the two original end-point network nodes 120, 130. However, also a multi-hop embodiment may be envisioned according to some embodiments, wherein several intermittent network nodes may forward data packets between the original end point network nodes.

In case the third network node 130 physically returns back to its original position, i.e. the position of FIG. 3A, the first network node 110 may observe that its power levels, i.e. P130 may be back to their original values. Additionally, the first network node 110 may also notice the third network node 130 transmitting duplicate ACKs as it may receive both the original packet from the second network node 120 as well as the relayed packet from the first network node 110, according to some embodiments. By using such heuristics instances of the first network nodes 110, it may conclude that the direct link between the second network node 120 and the third network node 130 is back and may terminate its relaying function, in order not to add interference and traffic load within the wireless communication system 100.

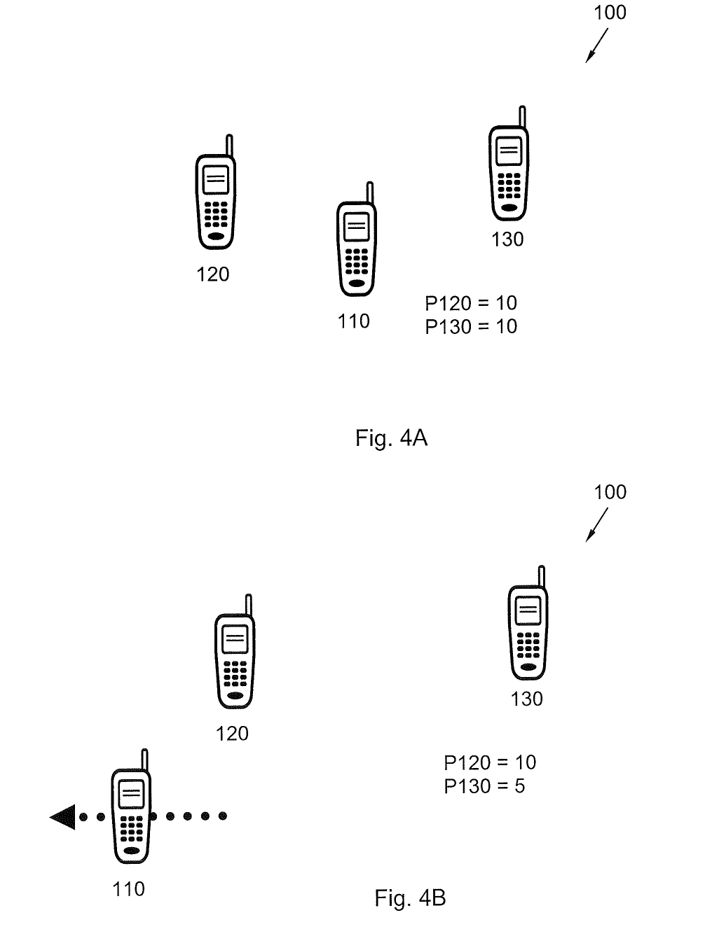

FIG. 4A is illustrating the first network node 110, the second network node 120 and the third network node 130, situated in relative vicinity, illustrating a scenario similar to the already discussed scenario of FIG. 3A. The second network node 120 and the third network node 130 have an ongoing communication session.

In the illustrated scenario shown in FIG. 4A, the first network node 110 does not relay packets even though it observes similar changes in power levels from the second network node 120 (P120) and the third network node 130 (P130), respectively.

Here, both the second network node 120 and the third network node 130 may remain stationary, but the first network node 110 may move to the left, as illustrated in FIG. 4B.

It may be noted that the first network node 110 according to some embodiments may not be aware that it is itself which has moved geographically. The first network node 110 may now observe a similar decrease in the level of received power P130 from the third network node 130, just in the scenario illustrated in FIG. 3B.

However, since the second network node 120 and the third network node 130 have exactly the same geographical positions, they may hear each other equally well, without problems to communicate. Then no MAC retransmissions may take place and hence the first network node 110 may not initiate relaying signals. In fact, if the first network node 110 starts relaying signals, it may interfere and disturb the communication between the second network node 120 and the third network node 130. Thus, appropriate activation and deactivation of the relaying functionalities within the first network node 110 may be appropriate in order to improve the signalling within the wireless communication system 100.

The scenario depicted in FIG. 4B illustrates that it is the combination of both physical signal power observed and protocol behaviour, which may be taken into account when determining whether to commence relaying. Thereby, the relay mechanism does not trigger unnecessarily and consume the limited capacity available in the shared channel.

As previously described, embodiments of the method and network nodes 110 may be applicable to any wireless communication system 100 where multiple network nodes 110, 120, 130, 140 may access a wireless broadcast medium for transmission and reception, and where a single transmission from one network node 110, 120, 130, 140 may be detected and received by every network node 110, 120, 130, 140 in the vicinity of the transmitting node.

The first network node 110 may according to some embodiments comprise a number of modules, in order to provide an autonomous relaying functionality. These modules are subsequently presented.

A first such module may comprise a Cross-layer Autonomous Relay Module (CARM). The CARM module may implement the autonomous relaying functionality in the first network node 110. It may, for example, comprise a piece of software in the first network node 110. The operation according to an embodiment described in more detail below.

Another embodiment may comprise another module which may be referred to as a Session List Store (SLS) module, which may comprise a memory storage where the CARM stores information about detected ongoing sessions in the vicinity.

Yet another module that may be comprised according to embodiments of the first network node 110, may be a Received Signal Power Function (RSPF) module. The RSPF may comprise representation of functionality in the first network node 110 that may be able to provide received signal power values of detected transmissions.

Some further embodiments may comprise a Reliable Communication Link Function (RCLF) module. The RCLF may be a representation of protocol functionality in the first network node 110. Embodiments of the RCLF in the first network node 110 may be configured to monitor the communication made between other nodes 120, 130 and detect a failure in the communication. In an example, the RCLF module may monitor the exchange of data packets and corresponding acknowledgements between a receiving network node 120 and a transmitting network node 130. According to some embodiments, the RCLF module may be able to inform the CARM module about detected acknowledgement packets. However, according to other embodiments, the RCLF module is instead configured to inform the CARM module when a data packet has been transmitted from the transmitting network node 130, without a corresponding acknowledgement from the receiving network node 120 has been detected. Further, the RCLF module may be configured to detect repeated transmission of the same data packet from the transmitting network node 130, according to some embodiments. In addition, the RCLF module may be configured to initiate re-transmissions i.e. forwarding of the data packet if no such acknowledgment packets are received, e.g. within some time window.

Yet another embodiment of the first network node 110 may comprise another module that may be referred to as a Packet Forwarding Function (PFF) module. The PFF module may comprise representation of functionality in the first network node 110 that may receive and store data packets from other wireless network nodes 120, 130 and transmit (forward) data packets to other wireless network nodes 120, 130. Typically such functionality embodies addressing protocols to determine if a received data packet is destined to the network node 110 itself, or to some other network node 110, 120, 130. In an example embodiment, the PFF module may be configured to inform the CARM module about the transmitter and receiver identities, i.e. addresses of a received data packet. The CARM module may also be configured to request the PFF module to forward/transmit a stored received data packet that was not destined to the network node 110, 120, 130 itself.

It may further be mentioned that throughout this document it has been described the first network node 110 as a physical independent entity, or even an apparatus. In reality, its functionality may be implemented as a piece of software. This may enable the first network node 110 to physically reside within existing network nodes 110, 120, 130 in the wireless communication system 100, as a software module and simplify its deployment in the wireless communication system 100.

An example of an embodiment of the first network node 110 may comprise a CARM operation, wherein, in a first action, data packets of sessions between two other wireless network nodes 120, 130 may be detected.

The first network node 110 that has implemented the CARM module may receive a data packet that has been transmitted from another network node 130. The data packet may be destined towards a second network node 120.

Further, the RSPF module may inform the CARM module about the received signal power. Independently the PFF module may inform the CARM module about the addresses of the transmitting third network node 130 and the second destination network node 120 according to some embodiments.

The CARM module may use the addresses and check the SLS module for a matching session entry. If the communication session is new, the CARM module may create a new entry and store the addresses and the received signal power. If the session exists the received signal power may be stored in the entry together with previously stored received signal powers.

In further addition, the CARM module may analyse the stored received signal powers and detect for example if a varying trend is observed, according to some embodiments. Thereby, it may be detected that the received signal power is fluctuating, which may be an indication that any, or several of the involved network nodes 110, 120, 130 is/are moving geographically.

A second example of an embodiment may also be described subsequently. Thus the CARM operation may in addition comprise detecting acknowledgement packets for received data packets between two other wireless network nodes 120, 130. The first network node 110 that has implemented the CARM module may receive an acknowledgment packet sent from a receiving network node 120, 130 of a data packet to the transmitting network node 120, 130 of the data packet.

The RCLF module may inform the CARM module that the packet may be an acknowledgement packet. Independently the PFF module may inform the CARM module about the addresses of the transmitting and destination network nodes 120, 130.

The CARM module may use the addresses to check the SLS module for a matching session entry according to some embodiments. It may find a matching session entry and record in a field that an acknowledgment for this session has been detected.

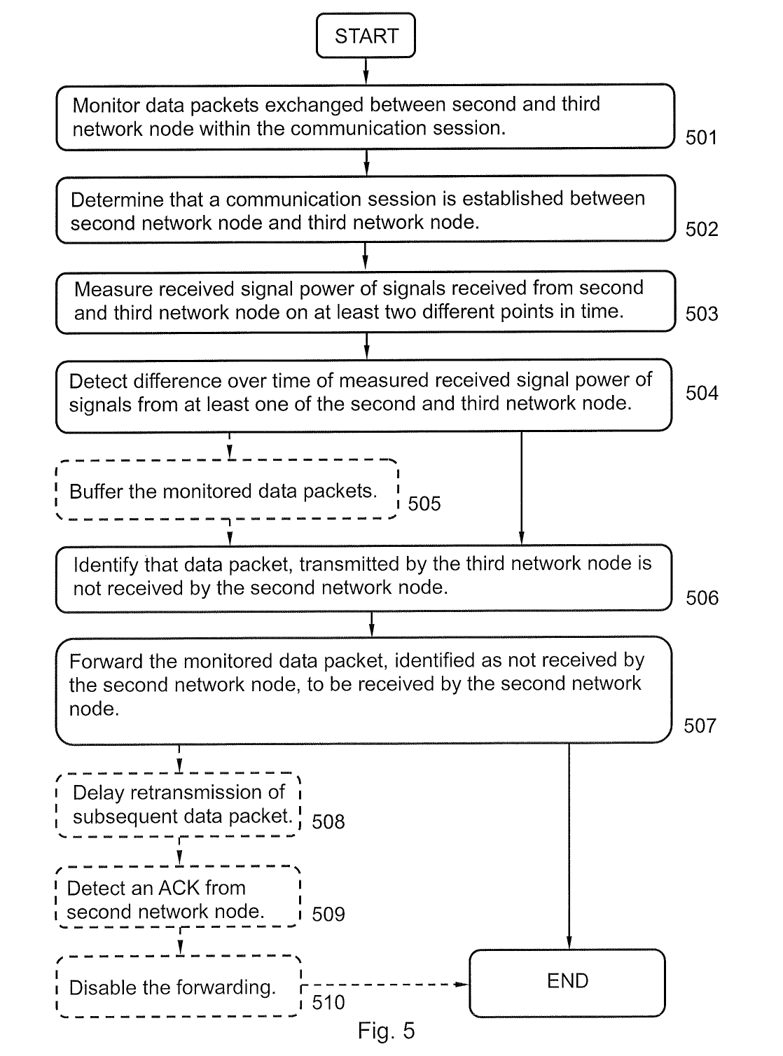

FIG. 5 is a flow chart illustrating embodiments of a method in a first network node 110. The method aims at forwarding a wirelessly transmitted data packet to a second network node 120, which data packet was received from a third network node 130 with the second network node 120 as the intended recipient of the data packet. The wireless transmission between the second network node 120 and the third network node 130 may be performed e.g. within a Wireless Local Area Network, a Wi-Fi network, a wireless broadband network, a wireless hotspot zone, or a network based on broadcasting of wireless data. A plurality of wireless communication sessions may be monitored simultaneously, according to some embodiments.

To appropriately forwarding the wirelessly transmitted data packet to the intended recipient, the method may comprise a number of actions 501-510.

It is however to be noted that some of the described actions, e.g. action 501-510 may be performed in a somewhat different chronological order than the enumeration indicates Further, any, some or all actions, such as e.g. 503 and 504 may be performed simultaneously or in a rearranged chronological order. Also, it is to be noted that some of the actions may be performed within some alternative embodiments, such as e.g. action 505, 508-510. The method may comprise the following actions:

Action 501

A data packet, or a plurality of data packets, exchanged between the second network node 120 and the third network node 130 is monitored.

The monitored data packet, or plurality of data packets, may be utilised in order to establish that a communication session between the transmitting third network node 130, and the receiving second network node 120 is established.

Action 502

A wireless communication session is determined to be established between the second network node 120 and the third network node 130.

It may alternatively be determined that a wireless communication session is established between the second network node 120 and the third network node 130, by monitoring 501 data packets exchanged between the second network node 120 and the third network node 130, using any of: packet inspection and checking address labels; packet inspection and buffering packets and matching up- and downstream packets; or by using information from another network node.

Action 503

The received signal power of wireless signals, received from the second network node 120 and from the third network node 130, respectively, are measured on at least two different points in time.

Action 504

A difference over time of measured 503 received signal power of wireless signals received from at least one of the second network node 120 and the third network node 130 is detected.

The difference over time of measured 503 received signal power of wireless signals received from at least one of the second network node 120 and the third network node 130 may comprise detecting that the difference over time of measured 503 received signal power of wireless signals exceeds a threshold value.

Action 505

This action may be comprised within some alternative embodiments, but not necessarily within all imaginable embodiments of the method.

The monitored 501 data packets exchanged between the second network node 120 and the third network node 130 may be buffered, for enabling instant forwarding of any data packet identified as not received by the intended recipient.

Thereby, thanks to the buffering of detected data packets, the first network node 110 may be appropriately prepared for forwarding data packets that may have been considered identified as not received by the second network node 120.

Action 506

A data packet, transmitted by the third network node 130 is identified as not received by the second network node 120.

The data packet may according to some embodiments be identified as not received by the second network node 120, by detecting a retransmission of the data packet, made by the third network node 130.

However, the data packet may be identified as not received by the second network node 120, according to some embodiments by detecting that the second network node 120 has not transmitted an acknowledgement for the data packet.

Further, alternatively, the data packet may be identified as not received by the second network node 120, by detecting that the second network node 120 has transmitted a non-acknowledgement for the data packet.

Action 507

The monitored 501 data packet, identified 506 as not received by the second network node 120 is forwarded, to be received by the second network node 120.

According to some embodiments, the data packet may be held before being forwarded. Thus, the first network node 110 may wait for a period of time before forwarding the data packet identified 506 as not received by the second network node 120, and refraining from forwarding the data packet if it is detected that another network node 140 may forward the data packet.

Upon forwarding the data packet, identified 506 as not received by the second network node 120, all data packets exchanged between the second network node 120 and the third network node 130 within the established wireless communication session may alternatively be continuously forwarded, according to some embodiments.

Action 508

This action may be comprised within some alternative embodiments, but not necessarily within all imaginable embodiments of the method.

The forwarding 507 of the subsequent data packet to be forwarded may be delayed, for a period of time, according to some embodiments. Thereby, the first network node 110 may detect that the second network node 120 has received the data packet directly from the third network node 130. Further, the first network node 110 may detect that another network node 140 has already started to forward the data packet.

Action 509

This action may be comprised within some alternative embodiments, but not necessarily within all imaginable embodiments of the method.

An acknowledgement from the second network node 120, acknowledging the reception of the data packet to be forwarded may be detected.

Action 510

This action may be comprised within some alternative embodiments, but not necessarily within all imaginable embodiments of the method.

The forwarding 507 of exchanged data packets within the communication session between the second network node 120 and the third network node 130 may, according to some embodiments be disabled.

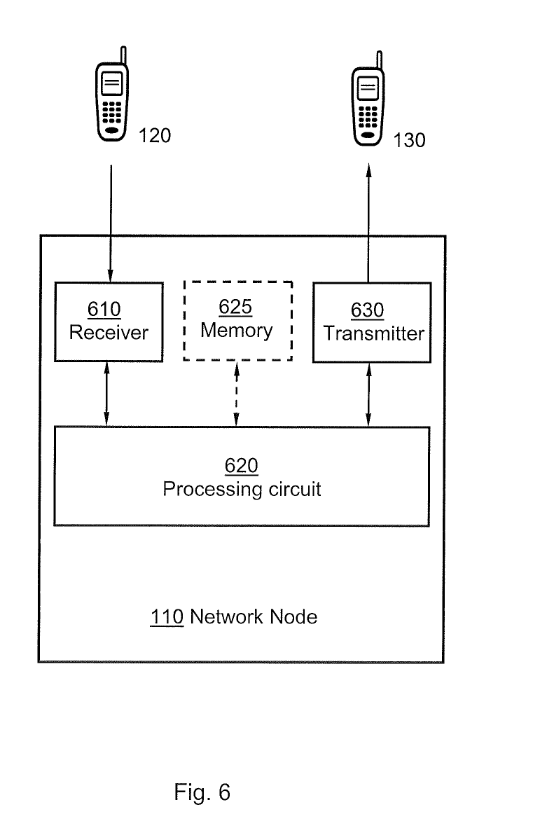

FIG. 6 is a block diagram illustrating a first network node 110. The first network node 110 may be configured to perform any, some or all of the previously described actions 501-510 for forwarding a wirelessly transmitted data packet to a second network node 120, which data packet was received from a third network node 130 with the second network node 120 as the intended recipient of the data packet.

For the sake of clarity, any internal electronics or other components of the first network node 110, not completely indispensable for understanding the disclosed method has been omitted from FIG. 6.

In order to perform the actions 501-510 correctly, the first network node 110 comprises a receiver 610. The receiver 610 is configured to receive wireless signals from the second network node 120 and from the third network node 130 respectively. Further, the first network node 110 comprises a processing circuit 620. The processing circuit 620 is configured to monitor data packets exchanged between the second network node 120 and the third network node 130. The processing circuit 620 is further configured to determine that a wireless communication session is established between the second network node 120 and the third network node 130. Additionally, the processing circuit 620 is also configured to measure the received signal power of wireless signals received from the second network node 120 and from the third network node 130, respectively, on at least two different points in time. Furthermore, the processing circuit 620 is, in addition, also configured to detect a difference over time of measured received signal power of wireless signals received from at least one of the second network node and the third network node. Additionally, the processing circuit 620 is also configured to identify that a data packet, transmitted by the third network node 130 is not received by the second network node 120. Also, in addition, the first network node 110 comprises a transmitter 630, configured to forward the monitored data packet, identified as not received by the second network node 120, to be received by the second network node 120.

Alternatively, the processing circuit 620 may further be configured to continuously forward all subsequent data packets exchanged between the second network node 120 and the third network node 130 within the established wireless communication session, upon forwarding the data packet identified as not received by the second network node 120, according to some embodiments.

Additionally, the processing circuit 620 may further be configured to delay the forwarding of the subsequent data packet to be forwarded, for a period of time. Further, the processing circuit 620 may in addition be configured to detect an acknowledgement from the second network node 120, acknowledging the reception of the data packet to be forwarded. Furthermore, the processing circuit 620 may also be configured to disable the forwarding of data packets exchanged between the second network node 120 and the third network node 130.

Also, furthermore, the processing circuit 620 may further be configured to wait for a period of time before forwarding the data packet identified as not received by the second network node 120, and refraining from forwarding the data packet if it is detected that another network node 140 is forwarding the data packet.

Further, a plurality of wireless communication sessions may be monitored simultaneously, according to some embodiments.

The processing circuit 620 may comprise e.g. one or more instances of a Central Processing Unit (CPU), a processing unit, a processor, a microprocessor, or other processing logic that may interpret and execute instructions. The processing circuit 620 may further perform data processing functions for inputting, outputting, and processing of data comprising data buffering and device control functions, such as call processing control, user interface control, or the like.

In addition, the first network node 110 may comprise a memory 625. The memory 625 may be configured to buffer monitored data packets exchanged between the second network node 120 and the third network node 130. Further, according to some embodiments, the memory 625 may be configured to store e.g. threshold values, information about neighbour network nodes 120, 130, 140 and other information that may serve the herein discussed methods, according to some embodiments.

Further, it is to be noted that some of the described units 610-630 comprised within the first network node 110 in the wireless communication system 100 are to be regarded as separate logical entities but not with necessity separate physical entities.

The actions 501-510 to be performed in the first network node 110 may be implemented through one or more processing circuits 620 in the first network node 110, together with computer program code for performing any, some or all of the functions of the actions 501-510 described above. Thus a computer program product, comprising instructions for performing the actions 501-510 in the first network node 110 may form a coordination group for coordinating multipoint wireless communication, when being loaded into the one or more processing circuits 620.

The computer program product mentioned above may be provided for instance in the form of a data carrier carrying computer program code for performing at least some of the actions 501-510 according to some embodiments when being loaded into the processing circuit 620. The data carrier may comprise e.g. a hard disk, a CD ROM disc, a memory stick, an optical storage device, a magnetic storage device or any other appropriate medium comprising a persistent or non-persistent memory such as a disk or tape that may hold machine readable data. The computer program product may furthermore be provided as computer program code on a server and downloaded to the first network node 110 remotely, e.g. over an Internet or an intranet connection.

When using the formulation “comprise” or “comprising” within the present context, it is to be interpreted as non-limiting, i.e. meaning “consist at least of”. The present methods and arrangements are not limited to the above described preferred embodiments. Various alternatives, modifications and equivalents may be utilized. Therefore, the above embodiments are not to be taken as limiting the scope of claimed protection, which instead is to be defined by the appending claims.

1-17. (canceled)

18. A method in a first network node, for forwarding a wirelessly transmitted data packet to a second network node, which data packet was received from a third network node with the second network node as the intended recipient of the data packet, the method comprising:
monitoring data packets exchanged between the second network node and the third network node,
determining that a wireless communication session is established between the second network node and the third network node,
measuring received signal power of wireless signals received from the second network node and from the third network node, respectively, on at least two different points in time,
detecting a difference over time of measured received signal power of wireless signals received from at least one of the second network node and the third network node,
identifying that a data packet, transmitted by the third network node is not received by the second network node,
forwarding the monitored data packet, identified as not received by the second network node, to be received by the second network node.

19. The method according to claim 18, further comprising
buffering the monitored data packets exchanged between the second network node and the third network node, for enabling instant forwarding of any data packet identified as not received by the intended recipient.

20. The method according to claim 18, wherein the data packet is identified as not received by the second network node, by detecting a retransmission of the data packet, made by the third network node.

21. The method according to claim 18, wherein the data packet is identified as not received by the second network node, by detecting that the second network node has not transmitted an acknowledgement for the data packet.

22. The method according to claim 18, wherein the data packet is identified as not received by the second network node, by detecting that the second network node has transmitted a non-acknowledgement for the data packet.

23. The method according to claim 18, further comprising waiting for a period of time before forwarding the data packet identified as not received by the second network node, and refraining from forwarding the data packet if it is detected that another network node is forwarding the data packet.

24. The method according to claim 18, wherein, upon forwarding the data packet identified as not received by the second network node, all subsequent data packets exchanged between the second network node and the third network node within the established wireless communication session are continuously forwarded.

25. The method according to claim 24, further comprising:
delaying the forwarding of a subsequent data packet to be forwarded, for a period of time,
detecting an acknowledgement from the second network node, acknowledging the reception of the data packet to be forwarded, and
disabling the forwarding of data packets exchanged between the second network node and the third network node.

26. The method according to claim 18, wherein:
detecting the difference over time of measured received signal power of wireless signals received from at least one of the second network node and the third network node comprises detecting that the difference over time of measured received signal power of wireless signals exceeds a threshold value.

27. The method according to claim 18, wherein a plurality of wireless communication sessions is monitored simultaneously.

28. The method according to claim 18, wherein it is determined that a wireless communication session is established between the second network node and the third network node, by monitoring data packets exchanged between the second network node and the third network node, using any of: packet inspection and checking address labels; packet inspection and buffering packets and matching up- and downstream packets; or by using information from another network node.

29. The method according to claim 18, wherein the wireless transmission between the second network node and the third network node is performed within a Wireless Local Area Network, a Wi-Fi network, a wireless broadband network, a wireless hotspot zone, or a network based on broadcasting of wireless data.

30. A network node, for forwarding a wirelessly transmitted data packet to a second network node, which data packet was received from a third network node with the second network node as the intended recipient of the data packet, the network node comprising:
a receiver, configured to receive wireless signals from the second network node and from the third network node respectively,
a processing circuit, configured to:
monitor data packets exchanged between the second network node and the third network node;
determine that a wireless communication session is established between the second network node and the third network node;
measure the received signal power of wireless signals received from the second network node and from the third network node, respectively, on at least two different points in time;
detect a difference over time of measured received signal power of wireless signals received from at least one of the second network node and the third network node;
identify that a data packet, transmitted by the third network node is not received by the second network node; and
a transmitter, configured to forward the monitored data packet, identified as not received by the second network node, to be received by the second network node.

31. The network node according to claim 30, further comprising:
a memory, configured to buffer monitored data packets exchanged between the second network node and the third network node.

32. The network node according to claim 30, wherein the processing circuit is further configured to continuously forward all subsequent data packets exchanged between the second network node and the third network node within the established wireless communication session, upon forwarding the data packet identified as not received by the second network node.

33. The network node according to claim 30, wherein the processing circuit is further configured to delay the forwarding of a subsequent data packet to be forwarded, for a period of time, detect an acknowledgement from the second network node, acknowledging the reception of the data packet to be forwarded, and disable the forwarding of data packets exchanged between the second network node and the third network node.

34. The network node according to claim 30, wherein the processing circuit is further configured to wait for a period of time before forwarding the data packet identified as not received by the second network node, and refrain from forwarding the data packet if it is detected that another network node is forwarding the data packet.
